(19) United States
(12) Patent Application Publication
(10) Pub. No.: US 2025/0058284 A1
(43) Pub. Date: Feb. 20, 2025

(54) VACUUM LEAK DETECTOR HAVING A SPRAYED-AGAINST MEMBRANE-TEST LEAK, AND METHOD

(71) Applicant: INFICON GMBH, Köln (DE)

(72) Inventors: Daniel WETZIG, Köln (DE); Jochen PUCHALLA-KÖNIG, Köln (DE); Silvio DECKER; Sebastian WEISS, Köln (DE)

(73) Assignee: INFICON GMBH, Köln (DE)

(21) Appl. No.: 18/723,123

(22) PCT Filed: Dec. 22, 2022
(86) PCT No.: PCT/EP2022/087584

§ 371 Date: Jun. 21, 2024

(30) Foreign Application Priority Data
Dec. 23, 2021 (DE) 10 2021 134 647.9

(51) Int. Cl. B01D 65/10; G01M 3/00; G01M 3/20

(52) U.S. Cl. CPC B01D 65/104; G01M 3/007; G01M 3/20; B01D 2325/04

(57) ABSTRACT

A vacuum leak detector has a housing enclosing a suction chamber, a vacuum pump evacuating the suction chamber, and a gas detector connected to the suction chamber. The housing has a test leak with a selectively gas-permeable membrane. The test leak connects the outer atmosphere of the housing with the suction chamber.

### CROSS-REFERENCE TO RELATED APPLICATIONS

The present application is a national stage application filed under 35 U.S.C. § 371 of PCT Application No. PCT/EP2022/087584, filed on Dec. 12, 2022, which claims priority to German patent application 102021134647.9, filed on Dec. 23, 2021, the entire contents of all of which are incorporated by reference herein.

### BACKGROUND OF THE DISCLOSURE

### 1. Field of the Disclosure

The disclosure relates to a vacuum leak detector with a test leak and to a method for testing the functionality of a leak detector.

### 2. Description of Related Art

To check the tightness or to find leaks on test objects using the test gas vacuum method, leak detectors are used that enable leak detection with test gas. The objects to be tested may be, for example, vacuum furnaces, manufacturing systems comprising a vacuum chamber in the semiconductor industry, various kinds of pipelines or other chambers.

For leak testing, the test object is evacuated. Evacuation may be performed using the pumping system associated with the test object or using a separate pumping system provided with the leak detector. A test gas detector is integrated into the leak detector, e.g., a mass spectrometer with which the test gas can be detected. The test gas may be, for example, helium or forming gas (95% nitrogen+5% hydrogen).

During the leak test, the locations to be tested (e.g. flange seals, weld seams, . . . ) are sprayed with the test gas on the atmospheric side of the test object. If there is a leakage channel at the sprayed location, the test gas flows together with ambient air through the leakage channel into the vacuum chamber and flows to the vacuum system. During this process, the test gas can be detected by the detection system (e.g. a mass spectrometer). The signal strength is a measure of the leakage rate and the temporal correlation of the sprayed location and the time and the signal response is an indication of the location of the leak.

If a leakage exists, a signal response occurs when the leakage point is sprayed, a tight test object is characterized by the absence of signals while being sprayed with test gas.

Likewise, in various error cases in this described method of leak testing, there is no signal response and cannot be distinguished from an actually tight test object. If the sensitivity of the detection system fails, there is also no signal response. Or if the spray gas source emits no test gas despite the actuation of the valve of the spray gas source, no signal response will occur despite a possible leak.

To check the functionality of the test system, a known leakage point is typically flanged to the vacuum system. Generally, such a defined leakage point is given by a so-called capillary leak. The capillary leak is dimensioned such that, when this test leak is sprayed, a clear signal response is output by the detection system. However, the capillary has to be sufficiently small so that the vacuum system and the test object are not negatively affected by the continuously inflowing amount of air. For this reason, such capillary leaks are dimensioned such that the channel diameter is only a few micrometers. As a consequence, the particles or condensing air humidity may clog the test leakage point. As a result thereof, a functional test system has seemingly failed, because the spray-on capillary leak is clogged.

WO 2006/120122 A1 describes a sniffer leak detector in which the test gas inlet comprises a quartz window sensor. A test leak is not provided there.

Conventionally, capillary leaks are used as test leaks in sniffer leak detectors of the type described in WO 2006/120122 A1, wherein the reference gas or test gas flowing out of the test leak towards the atmosphere is drawn in and detected using a so-called sniffer probe.

### SUMMARY OF THE DISCLOSURE

Against this background, it is an object of the disclosure to provide a vacuum leak detector with an improved test leak and to enable a corresponding leak detection method.

According to the disclosure, a test leak with a selectively gas-permeable membrane, which connects the outer atmosphere of the housing with the suction chamber, is provided at the housing enclosing the suction chamber of the vacuum leak detector, which housing is connected to a vacuum pump evacuating the suction chamber and to a gas detector connected to the suction chamber. After the suction chamber is evacuated by the vacuum pump, the test leak is sprayed with a test gas such that the test gas selectively passes through the membrane into the interior of the suction chamber, while air or atmospheric gases from the environment of the vacuum leak detector are blocked by the membrane. The test gas that has entered the suction chamber through the membrane is detected by the gas detector. The membrane of the disclosure allows determining whether the measuring signal of the test gas measured by the gas detector corresponds to the measuring signal to be expected when the vacuum leak detector functions without restrictions. In this manner, the functionality of a vacuum leak detector can be tested in a simple manner. In addition, it is tested that the spray gas source used to apply the test gas functions properly, i.e. supplies the desired type of test gas in a sufficient amount.

The test leak can be designed as a spray-on leak to selectively direct test gas sprayed onto the test leak from outside through the membrane into the suction chamber, while gases different from the test gas are blocked.

The membrane of the test leak can comprise quartz for the selective passage of helium, neon, or hydrogen, or can be made of quartz. As an alternative or in addition, the membrane can comprise or consist of palladium for the selective passage of hydrogen and/or silver for the selective passage of oxygen.

The material of the membrane can be designed as a thin-walled closed tube, for example in the form of a glass finger.

The membrane material can be configured to selectively direct or block the test gas depending on the temperature, while a heater for heating the membrane is provided.

The membrane can have a layer thickness of a few micrometers and preferably approximately 100 μm at most.

The test leak may comprise a flange-type holder for the membrane, which is inserted into an opening of the housing. The holder may preferably be covered by a protective grid on its outer side and/or its inner side.

The test leak may comprise a plurality of channels, each closed by a or the selectively gas-permeable membrane. Here, the membrane can be attached to a membrane chip, the membrane chip having a thickness of preferably less than one centimeter and more preferably less than one millimeter. The membrane chip has a window covered by the membrane, which is designed as a channel that completely penetrates the membrane chip and has a diameter of at most approximately 1000 μm and at least approximately 10 μm so that an end of the channel is covered by the membrane. Here, the membrane preferably seals the channel towards the atmosphere side, i.e. it covers the end of the channel opposite the suction chamber so as to prevent the ingress of water vapor or dirt particles from the environment into the channel.

In one embodiment, the membrane can be attached to a membrane chip which comprises at least one membrane window covered by the membrane and has a thickness of preferably less than 1 mm. The membrane window is preferably supported by an open-pore porous structure, such as a grid or a porous solid material, so as to support and stabilize the membrane.

A selective gas inlet is provided on the vacuum system of the leak detector. The selective gas inlet is implemented by a membrane that is sealed or almost impermeable to atmospheric gases. In this manner, the vacuum system is unaffected in the absence of test gas. As soon as test gas is sprayed onto the membrane spray-on leak, the test gas permeates through the membrane into the vacuum system and is detected there by the detection system, thereby confirming the functionality of the overall system (detection system) and the test gas spray source.

Depending on the test gas used, suitable membrane materials can be selected:
for the selective inlet of helium, quartz is used,
for the selective inlet of hydrogen (a component of forming gas), palladium is used,
for the selective inlet of oxygen, silver is used.

The material can be designed as a thin-walled closed tube (glass finger). In such a variant, the material must be heated so that the diffusion rate of the gas through the separating layer is sufficiently fast. When designed as a thin membrane a few micrometers thick, it is sufficient to use the membrane at room temperature to obtain a sufficiently fast response.

### BRIEF DESCRIPTION OF THE DRAWINGS

An embodiment of the disclosure will be explained in detail hereunder with reference to the Figures.

FIG. 1 shows a first embodiment according to the present disclosure.

FIG. 2 shows a detail of FIG. 1.

FIG. 3 shows a detail of FIG. 2.

### DETAILED DESCRIPTION OF THE DISCLOSURE

The vacuum leak detector 10 illustrated comprises a housing 14 enclosing a suction chamber 12, which is connected to a gas detector 18 and a vacuum pump 20 in a gas conducting manner via a vacuum line 16. The housing 14 has a test gas inlet 22 through which test gas to be tested is drawn into the suction chamber 12 from the outer environment 24 of the housing 14, to be analyzed by the gas detector 18.

In order to be able to check the functionality of the vacuum leak detector 10, the housing 14 is provided with test leak 26 which completely covers an opening in the housing 14. The test leak 26 is illustrated in more detail in the exploded view of FIG. 2. The test leak 26 has a flange-type holder 28 that fits completely in the associated opening of the housing 14 and closes the same in a sealing manner. In the embodiment, the holder 28 is designed as a circular disc with a recess 30 being formed in the area of the centre thereof. A hole extending through the holder 28 is formed at the bottom of the recess 30. A selectively gas-permeable membrane is inserted into the recess 30 as a membrane chip 32, which completely covers the hole in the bottom of the recess 30 in a gas-tight manner. The membrane 32 is selectively gas-permeable to a particular type of gas and blocks all other types of gas.

The upper side of the holder 28 facing the outer environment 24 and the lower side of the holder 28 facing the suction chamber 12 are each covered by a protective grid that completely covers the recess 30 with the membrane 32 and the hole covered by the membrane 32. Both protective grids 34 are fixedly screwed to the holder 28 by means of screw connections.

The structure of the membrane 32 is shown in more detail in FIG. 3.

Accordingly, the membrane 32 is designed as a quartz membrane chip and is provided in its centre with about 50 holes 36 formed as channels extending completely through the membrane chip 32, the holes being arranged in a grid with uniform spacing between them. Each of the holes 36 is closed by a quartz membrane with a thickness of about 10 μm. The thickness of the membrane chip 32 is about 0.6 mm. Each hole 36 forms a quartz window is selectively gas-permeable to helium at a membrane temperature of about 25° C., while other gases contained in air do not pass through the membrane 32. Besides helium, only neon and hydrogen permeate through quartz, but only to a lesser extent compared to helium, i.e. they could basically also be used as a test gas when using the spray-on leak with a quartz membrane.

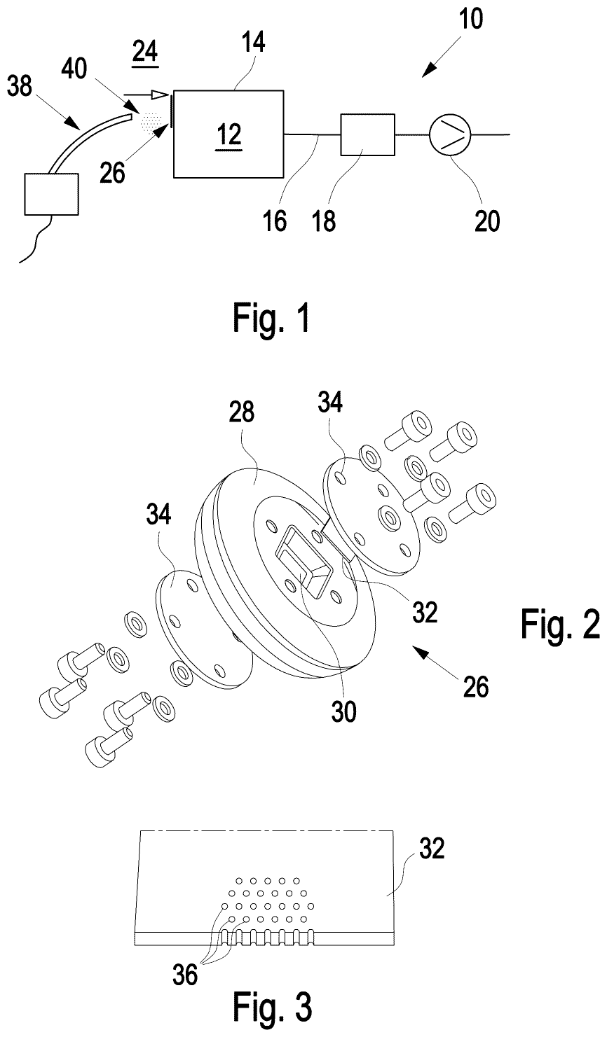

The protective grids 34 protect the membrane chip 32 from direct contact with, for example, a spray gun 38, when, as illustrated in FIG. 1, the spray gun spray helium 40 onto the test leak 26 in the direction of the arrow in FIG. 1. The protective grid 34 on the lower side of the holder 28, i.e. on the side facing the suction chamber 12, also protects the membrane chip 32 on the one hand and the vacuum system on the other hand should the chip break or individual broken-out membrane windows be drawn by the vacuum pump 20.

1-11. (canceled)

12. A vacuum leak detector comprising:
a housing enclosing a suction chamber;
a vacuum pump evacuating the suction chamber; and
a gas detector connected to the suction chamber,
wherein the housing comprises a test leak with a membrane that is selectively gas-permeable, and wherein the test leak connects an outer atmosphere of the housing with the suction chamber.

13. The leak detector according to claim 12, wherein the test leak is designed as a spray-on leak to selectively direct a test gas sprayed onto the test leak from outside through the membrane into the suction chamber while gases different from the test gas are blocked.

14. The leak detector according to claim 13, wherein the membrane of the test leak comprises quartz for selectively passing helium, neon, hydrogen, palladium for selectively passing hydrogen, and/or silver for selectively passing oxygen.

15. The leak detector according to claim 12, wherein the membrane has a material formed as a thin-walled closed tube.

16. The leak detector according to claim 15, wherein the thin-walled closed tube is a glass finger.

17. The leak detector according to claim 12, further comprising a heater for heating the membrane, wherein the membrane has a material that selectively conducts or blocks heat depending on temperature.

18. The leak detector according to claim 12, wherein the membrane has a layer thickness of a few micrometers.

19. The leak detector according to claim 12, wherein the membrane has a layer thickness of at most 100 μm.

20. The leak detector according to claim 12, wherein the test leak comprises a flange-type holder for the membrane inserted into an opening of the housing.

21. The leak detector according to claim 20, wherein the flange-type holder is covered by a protective grid on an outer side and/or an inner side.

22. The leak detector according to claim 12, wherein the test leak comprises a plurality of channels closed by the membrane.

23. The leak detector according to claim 12, wherein the membrane is attached to a membrane chip having a thickness of less than 1 cm, the membrane chip comprising at least one membrane window covered by the membrane, each membrane window being designed as a channel completely penetrating the membrane chip and having a diameter of at most about 1000 μm and at least about 10 μm so that an end of the channel is covered by the membrane.

24. The leak detector according to claim 12, wherein the membrane is attached to a membrane chip having a thickness of less than 1 mm, the membrane chip comprising at least one membrane window covered by the membrane, each membrane window being designed as a channel completely penetrating the membrane chip and having a diameter of at most about 1000 μm and at least about 10 μm so that an end of the channel is covered by the membrane.

25. The leak detector according to claim 12, wherein the membrane is attached to a membrane chip and has a thickness of less than 1 mm, and wherein the membrane chip comprises at least one membrane window covered by the membrane and supported by an open-pore porous structure.

26. A method for testing the functionality of the leak detector according to claim 12, the method comprising the steps of:
evacuating the suction chamber using the vacuum pump;
spraying the test leak with a test gas so that the test gas selectively passes through the membrane into an interior of the suction chamber while air or atmospheric gases from an environment of the vacuum leak detector are blocked by the membrane;
detecting the test gas that has passed through the membrane into the suction chamber using the gas detector; and
determining whether a measuring signal of the gas detector corresponds to the measuring signal to be expected when the vacuum leak detector is fully functional.
